(19) United States
(12) Patent Application Publication
(10) Pub. No.: US 2005/0226627 A1
(43) Pub. Date: Oct. 13, 2005

(54) Dispersion compensation in optical communications systems

(76) Inventor: Harry Richard Claringburn, Nottingham (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/500,675

(22) PCT Filed: Dec. 24, 2002
(86) PCT No.: PCT/GB02/05920

§ 371 Date: Apr. 5, 2005

(30) Foreign Application Priority Data
Jan. 4, 2002 (GB) 0200175.8

(51) Int. Cl. H04B 10/12

(52) U.S. Cl. 398/147

(57) ABSTRACT

Dispersion compensation is applied to an optical signal first by a coarse compensation applied to the signal multiplex on a communications network and then by a fine adjustable compensation applied to individual signal channels dropped from the network. The error rate is measured, for example using forward error correction, and the dispersion compensation is set to minimize the error rate.

This invention relates to apparatus and methods for compensating for dispersion in optical telecommunications systems.

A major requirement of any photonics system is to provide the maximum amount of remotely configurable functionality and flexibility.

Dispersion on a high bit rate communications system, both chromatic and polarisation are major problems which usually require some kind of compensation or correction to be applied. Due to the nature of the traffic path distribution around photonic add/drop rings, dispersion compensation has to be done very accurately on a span by span basis so that the accumulated error on a path over multiple spans does not exceed the maximum permissible dispersion. Compensation is therefore specific to a particular fibre route. When this route changes, for example because the system has been reconfigured, the compensation requires modifying. This is difficult to do without knowledge of the new route. This is less of a problem on line networks but in a ring network, traffic can have come from anywhere on the network.

Thus, there is a problem in providing accurate dispersion compensation in systems that are remotely configurable. The invention aims to overcome this problem and, in its broadest form, uses a measure of the channel error rate to provide a basis for varying dispersion compensation applied to a signal dropped from the network.

More specifically, there is provided a method of performing dispersion compensation on an optical communications signal, comprising coarsely dispersion compensating the signal as an optical multiplex on a communications network, dropping the signal from the network, and applying an adjustable dispersion compensation to the dropped signal based on a measure of the error rate in the signal.

The invention also provides a method of performing dispersion compensation on an optical communications signal dropped from an optical communications network, comprising splitting the signal multiplex dropped from the network into a plurality of separate signal channels and performing an adjustable dispersion compensation on each channel based on a measure of the error rate in the channel.

The invention further provides apparatus for performing dispersion compensation on an optical communications signal, comprising means for performing coarse dispersion compensation on the signal multiplex on a communications network, means for dropping the signal multiplex from the network, and means for applying an adjustable dispersion compensation to the dropped signal based on a measure of the error rate in the signal.

The invention further provides an add/drop node for an optical communications network, comprising a splitter for dropping a signal multiplex from the network, means for separating the signal multiplex into a plurality of channels, means for measuring the error rate in a channel, and means for applying an adjustable dispersion compensation based on a measure of the error rate.

In an embodiment of the invention, coarse dispersion compensation is applied to the signal multiplex on the network and a fine adjustable compensation is applied to individual channels dropped from the network, in accordance with a measure of signal error rate. This has the advantage that dispersion compensation can be controlled remotely and can be adjusted to take into account the origin of the signal source.

Preferably, a feedback signal is derived from the error rate and used to provide a control signal to set the adjustable dispersion compensation to minimise the error rate. Preferably, the control signal is dithered to find the compensation setting giving the minimum error rate.

Preferably, the signal is forward error corrected (FEC). A bit error rate signal is derived from a FEC decoder and used to generate the control signal. This has the advantage that changes in error rate caused by dithering the control signal will not be seen by the user at the FEC decoder and corrector will correct the errors before the signal is passed to the user.

An embodiment of the invention will now be described, by way of example only, and with reference to the accompanying drawings in which:

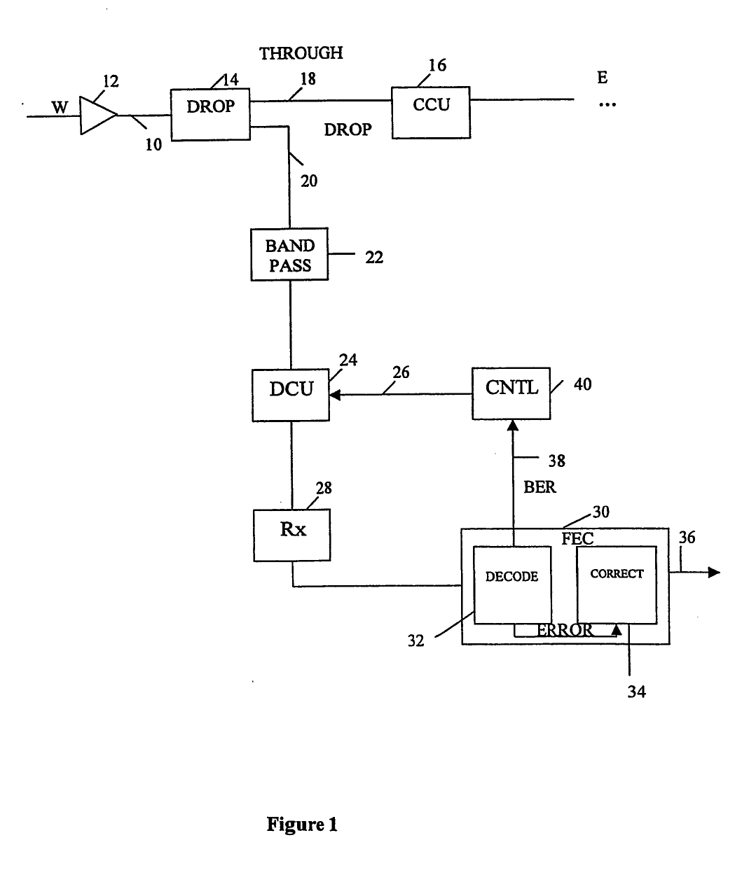

FIG. 1 illustrates schematically, a drop node embodying the invention; and

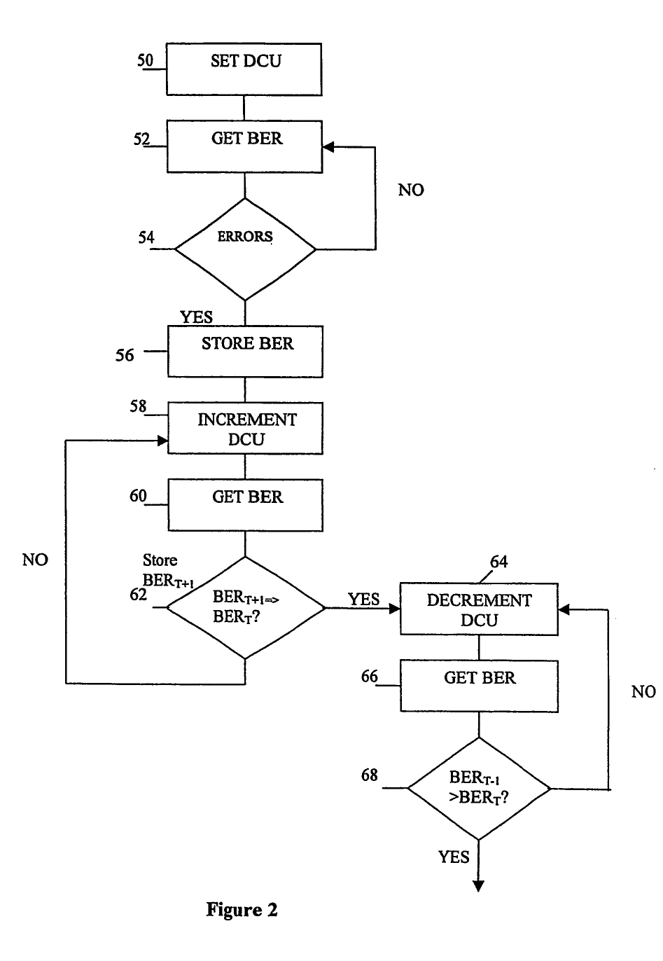

FIG. 2 is a flow chart showing a process embodying the invention.

The embodiment to be described uses a combination of coarse and fine compensation to correct for dispersion. Fine compensation uses a measure of the signal error rate to derive a dispersion compensation signal which is applied to the signal after it is dropped from the network before it reaches the user. The embodiment to be described uses forward error correction to derive the error rate and the correction signal although other measures of the error rate are possible. For example, the error rate could be determined directly from the data, if the data format is known, or from the wrapper if present.

A coarse compensation is first applied to the signal on the network. Coarse compensation may be implemented in a known manner using either dispersion compensating fibre (DCF) or a Fibre Bragg grating. DCF fibre has opposite sign dispersion to conventional fibre and the length of the DCF fibre is altered to give the desired amount of dispersion compensation. A fine adjustable dispersion compensation component is then applied at each drop path to perform the final dispersion compensation. As the signal being dropped may be remotely configured to come from a number of different sources, there may be problems in resetting and maintaining optimisation of the fine dispersion compensator without causing errors to the delivered clients traffic. The preferred embodiment to be described uses the forward error correction (FEC) bit error rate to overcome this problem. Referring now to FIG. 1, for simplicity, only the drop side of an add/drop node is shown. The construction of the add side is well known to those skilled in the art. Also only the W/E fibre of a two fibre ring is shown. In practice, the network will include an E/W fibre and part of the drop side circuitry will be duplicated to drop signals off both fibres of the network.

The network is a Dense Wavelength Division Multiplex (DWDM) network which carries a plurality of optical channels, typically 32 channels. The signal data in the channels is encoded using a forward error correction algorithm such as the Reed-Solomon algorithm. This enables data errors to be detected and corrected before the data reaches the user, ensuring that the correction process is transparent to the user. The use of FEC introduces a data overhead into the traffic carried on the network but increases ruggedness.

The FEC encoded DWDM signal is carried on the W/E fibre 10 of the ring network and amplified by EDFA amplifier 12. The amplifier stage is not always necessary, depending on the size of the network and the span between network nodes. The multiplexer signal is then passed to a drop coupler 14 which splits the signal into two paths. The through path 18 remains on the network and passes to a channel control unit 16 and the drop path 20 is dropped to be sent to a user, after processing.

The multiplex is band pass filtered by a filter 22 to split out individual channels from the multiplexer. It will be appreciated that only one channel is shown in the figure and that the subsequent processing to be described will be applied to all the dropped channels. The band pass filter function can be performed in a number of ways, for example, the DWDM signal could be demultiplexed and individual outputs selected, or a 1:n splitter could be used, where n is the number of channels, with a filter on each of the outputs tuned to select individual channels.

The selected output channel is passed to a dispersion compensation unit 24 which applied a dispersion compensation to the selected channel under the control of a control signal 26. The dispersion compensated signal is then passed to a receiver 28 where it is converted into a electrical signal and decoded using a forward error correction (FEC) chip 30. The FEC chip performs two functions. The first is a decode function which decodes the received signal and derives an error signal. The second is a correction function 34 which corrects the decoded signal under the control of the error signal derived by the decoder 32. The decoded and corrected signal is 36 then passed to the user.

The decoder also produces a bit error rate signal BER 38 which is an indication of the number of errors in the received signal. The BER is used as an input to a controller 40 which control the amount of dispersion compensation applied to the signal by the dispersion compensation unit 24.

The dispersion compensation unit operates to minimise the error rate, subject to there being an adequate signal to noise ratio. In order to find the minimum error rate, the controller 40 dithers the dispersion compensation control about an initial estimated set point to find the minimum error rate. Because the FEC chip 30 corrects errors before the signal is passed to the user, the dithering, and the attendant variation in error rate is totally transparent to the user who only sees corrected data.

FIG. 2 illustrates how the process operates. A coarse dispersion compensation is set on the network and so the circuit of FIG. 1 only performs a fine adjustable dispersion compensation. At step 50, the dispersion compensation unit 24 is set to an estimated position by the controller 40. At step 52, the bit error rate 38 is retrieved from the FEC decoder 32 and stored. At step 54 a determination is made of whether there are any errors in the signal. If there are not, the bit error rate is necessarily at a minimum and further correction is not necessary. If there are errors, which will usually be the case, the BER is stored at step 56 and the dispersion compensation incremented (or decremented) at step 58. The BER at this position is then retrieved at step 60 and, at step 62 stored compared to the previous BER. If the error rate has decreased, the compensation is being corrected in the correct sense and the compensation is incremented again until the error rate rises again. That point is established as the minimum error rate. If the error rate increases after the first increment, the sense of correction was incorrect and the DCU setting is decremented from its original at step 64. Again, the BER is retrieved at step 66 and, at step 68 compared with the original rate BERT. If the new rate BERT-1 is lower, the DCU is decremented again until the error rate eventually rises, showing that the previous position generated the minimum error rate.

It will be seen that the combination of coarse dispersion compensation on the network and adjustable fine compensation at the drop side of network nodes enables the compensation to be adjusted remotely. This is highly advantageous and enables the compensation to be altered without the network or node having to be taken out of service and without any on site attention. The use of an error measurement is advantageous as it gives an accurate view of the suitability of the dispersion compensation being applied at any given time. Use of a bit error rate derived from a forward error correction decoder is especially advantageous as it allows the dispersion compensation to be fine tuned without the attendant change in error rate affecting the quality of the data output to the user.

Various modifications are possible to the embodiment described without departing from the scope of the invention. For example, fine tuning of the dispersion compensation could be based on a different measure of the error rate in the channel or channels in question.

1-14. (canceled)

15. A method of performing dispersion compensation on an optical communications signal, comprising the steps of:
a) coarsely dispersion compensating the signal as an optical multiplex on a communications network;
b) dropping the signal from the network to produce a dropped signal; and
c) applying an adjustable dispersion compensation to the dropped signal based on a measure of error rate in the signal.

16. The method according to claim 15, wherein the step of applying the dispersion compensation is performed by applying the dispersion compensation to individual channels of the signal multiplex dropped from the network.

17. The method according to claim 15, and using the measure of the signal error rate to form a feedback signal to control the adjustable dispersion compensation.

18. The method according to claim 15, wherein the step of applying the dispersion compensation based on the measure of the error rate is performed by adjusting the dispersion compensation to minimize the error rate.

19. The method according to claim 15, and forward error correction (FEC) encoding the optical communications signal, and deriving the measure of the error rate as a bit error rate from an FEC decoder.

20. The method according to claim 18, and the step of dithering the dispersion compensation to determine the dispersion compensation having a minimum error rate.

21. A method of performing dispersion compensation on an optical communications signal dropped from an optical communications network, comprising the steps of:
a) splitting a signal multiplex dropped from the network into a plurality of separate signal channels; and
b) performing an adjustable dispersion compensation on each channel based on a measure of error rate in the respective channel.

22. An apparatus for performing dispersion compensation on an optical communications signal, comprising:
a) means for performing coarse dispersion compensation on a signal multiplex on a communications network;
b) means for dropping the signal multiplex from the network to produce a dropped signal; and
c) means for applying an adjustable dispersion compensation to the dropped signal based on a measure of error rate in the signal.

23. The apparatus according to claim 22, comprising means for splitting the dropped signal multiplex into a plurality of separate channels, wherein the adjustable dispersion compensation means applies an adjustable compensation to the separate channels.

24. The apparatus according to claim 23, comprising means for measuring the error rate in a respective channel to obtain a measured error rate, and means for deriving and applying a control signal to adjust the dispersion compensation means from the measured error rate.

25. The apparatus according to claim 24, wherein the means for deriving and applying the control signal adjusts the dispersion compensation means to minimize the measured error rate.

26. The apparatus according to claim 24, wherein the signal carried on the network is forward error corrected (FEC), and wherein the means for measuring the error rate comprises an FEC decoder for outputting a bit error rate signal to the means for deriving and applying the control signal.

27. The apparatus according to claim 24, wherein the means for deriving and applying the control signal comprises means for dithering the control signal to set the dispersion compensation means such that the measured error rate is a minimum.

28. An add/drop node for an optical communications network, comprising:
a) a splitter for dropping a signal multiplex from the network;
b) means for separating the signal multiplex into a plurality of channels;
c) means for measuring error rate in a respective channel; and
d) means for applying an adjustable dispersion compensation to the respective channel based on the error rate measured by the measuring means.
